(19) United States
(12) Patent Application Publication
(10) Pub. No.: US 2021/0258842 A1
(43) Pub. Date: Aug. 19, 2021

(54) METHODS AND SYSTEMS FOR ONLINE SERVICES APPS, BROWSERS, OR EXTERNAL DEVICES TO REQUEST UE HANDOVER VIA MODEM APIs

(71) Applicant: Telefonaktiebolaget LM Ericsson (publ), Stockholm (SE)

(72) Inventors: Virgilio Fiorese, McKinney, TX (US); Nipun Sharma, New Delhi (IN)

(21) Appl. No.: 16/973,115

(22) PCT Filed: Jun. 8, 2018
(86) PCT No.: PCT/IB2018/054181

§ 371 Date: Dec. 8, 2020

(51) Int. Cl. H04W 36/00; H04W 12/069; H04W 48/16

(52) U.S. Cl. CPC H04W 36/00837; H04W 48/16; H04W 12/069; H04W 36/0016

(57) ABSTRACT

Methods and systems for online services apps, browsers or external devices to request client device handover via modem Application Programming Interfaces (APIs) are presented. According to one aspect of the present disclosure, a method for applications within or attached to a client device to request handover comprises, at the client device: receiving, at an API layer within the client device, a first request to trigger a handover required message; sending, by the API layer to a modem within the client device, the first request; preparing, by the modem, a handover required message; and sending, by the modem, the handover required message to a Radio Access Node (RAN) serving the client device.

### TECHNICAL FIELD

The present disclosure relates to traffic routing and network automation within a telecommunications network, such as in a Fifth Generation (5G) network or a Long Term Evolution (LTE) network.

### BACKGROUND

In current Fifth Generation (5G) Core (5GC)/New Radio (NR) specifications, network elements such as a Remote Radio Unit (RRU), a Base Band Unit (BBU), a Core Access and Mobility Management Function (AMF), and a Network Data Analytics Function (NWDAF), are the network elements involved handover procedures. Similar to previous cellular technologies such as Long Term Evolution (LTE), Third Generation (3G), Second Generation (2G), and so on, only network functions within the operator network have any influence to trigger a handover process after exchanging signaling with User Equipment (UE) being served by the network.

However, “third party” network elements—defined herein as network elements that are outside of a network operator's domain and are thus not considered part of the core network—may have access to a wealth of information that could provide valuable insight into network conditions, both instantaneous conditions and long term trends. For example, Application Functions (AFs) owned and/or controlled by online service providers, also known as Over-the-Top (OTT) providers, such as search engines, social media platforms, etc., often have detailed user data that includes not only Quality of Service (QoS) information but also Quality of Experience (QoE). Such data may be representative of a large number of users operating a large variety of types of client devices under a large variety of conditions.

Although this information could be enormously valuable to the handover decision-making process, there is currently no mechanism for such information to be used for this purpose.

### SUMMARY

Methods and systems for online services apps, browsers or external devices to request client device handover via modem Application Programming Interfaces (APIs) are herein provided.

According to one aspect of the present disclosure, a method for applications within or attached to a client device to request handover comprises, at the client device: receiving, at an API layer within the client device, a first request to trigger a handover required message; sending, by the API layer to a modem within the client device, the first request; preparing, by the modem, a handover required message; and sending, by the modem, the handover required message to a Radio Access Node (RAN) serving the client device.

In some embodiments, the method further comprises, upon receiving the first request, determining whether the first request is allowed and sending the first request to the modem only when the first request is allowed.

In some embodiments, receiving the first request comprises receiving the first request from a native application within the client device.

In some embodiments, the native application comprises a browser or a social media application.

In some embodiments, receiving the first request comprises receiving the first request from an external application attached to the client device.

In some embodiments, receiving the request from the external application comprises receiving the request via an external interface of the client device.

In some embodiments, the external interlace of the client device comprises a wired or wireless interface.

In some embodiments, sending the handover required message to the RAN comprises sending the handover required message as an N1 interface signaling message to the RAN. In these embodiments, the N1 interface is enhanced from Third Generation Partnership Project (3GPP) current capabilities in order to allow the User Equipment (UE) to have handover required capability.

In some embodiments, the method further comprises, prior to receiving the first request to trigger a handover required message: sending, by a requesting application to an Application Function (AF), a request to certify the requesting application; and receiving, from the AF, a response to the request to certify the requesting application.

In some embodiments, the received response indicates that the requesting application is certified.

In some embodiments, the response comprises a certificate for use by the requesting application.

In some embodiments, the method further comprises: sending, by the requesting application to the API layer, a request to validate the received certificate; sending, by the API layer to a Network Exposure Function (NEF) the request to validate the certificate; receiving, by the API layer from the NEF, a notification that the certificate is valid or invalid; and forwarding, by the API layer to the requesting application, the received notification that the certificate is valid or invalid.

According to another aspect of the present disclosure, a client device for operating in a telecommunications network and that allows applications within or attached to the client device to request handover is adapted to: receive, at an API layer, a first request to trigger a handover required message; send, by the API layer to a modem within the client device, the first request; prepare, by the modem, a handover required message; and send, by the modem, the handover required message to a RAN serving the client device.

In some embodiments, the client device is further adapted to perform any of the client device methods disclosed herein.

According to another aspect of the present disclosure, a client device for operating in a telecommunications network and that allows applications within or attached to the client device to request handover comprises one or more modules operable to: receive, at an API layer, a first request to trigger a handover required message; send, by the API layer to a modem within the client device, the first request; prepare, by the modem, a handover required message; and send, by the modem, the handover required message to a RAN serving the client device.

In some embodiments, the one or more modules are further operable to perform any of the client device methods disclosed herein.

According to another aspect of the present disclosure, a non-transitory computer readable medium stores software instructions that, when executed by one or more processors of a client device for operating in a telecommunications network and that allows applications within or attached to a client device to request handover, cause the client device to: receive, at an API layer, a first request to trigger a handover required message; send, by the API layer to a modem within the client device, the first request; prepare, by the modem, a handover required message; and send, by the modem, the handover required message to a RAN serving the client device.

In some embodiments, the non-transitory computer readable medium described above stores software instructions that when executed by the one or more processors of the client device further cause the client device to perform any of the client device methods described herein.

According to another aspect of the present disclosure, a computer program comprises instructions which, when executed by at least one processor, cause the at least one processor to carry out any of the client device methods described herein.

According to another aspect of the present disclosure, a method for applications within or attached to a client device to request handover comprises, at a RAN: receiving, from a client device a handover required message; and sending the received handover required message to a Core Access and Mobility Management Function (AMF).

According to another aspect of the present disclosure, a RAN for operating in a telecommunications network and that allows applications within or attached to a client device to request handover is adapted to: receive, from a client device a handover required message; and send the received handover required message to an AMF.

According to another aspect of the present disclosure, a RAN for operating in a telecommunications network and that allows applications within or attached to a client device to request handover comprises one or more modules operable to: receive, from a client device a handover required message; and send the received handover required message to an AMF.

According to another aspect of the present disclosure, a non-transitory computer readable medium stores software instructions that when executed by one or more processors of a RAN, cause the RAN to: receive, from a client device a handover required message; and send the received handover required message to an AMF.

According to another aspect of the present disclosure, a computer program comprises instructions which, when executed by at least one processor, cause the at least one processor to carry out the steps of: receiving, from a client device a handover required message; and sending the received handover required message to an AMF.

According to another aspect of the present disclosure, a method for an AF operating in a telecommunications network to request handover comprises, at the AF: detecting a handover required condition; and notifying, directly or via a NEF, an AMF that a handover is required.

According to another aspect of the present disclosure, an AF for operating in a telecommunications network is adapted to: detect a handover required condition; and notify, directly or via a NEF, an AMF that a handover is required.

According to another aspect of the present disclosure, an AF for operating in a telecommunications network comprises one or more modules operable to: detect a handover required condition; and notify, directly or via a NEF, an AMF that a handover is required.

According to another aspect of the present disclosure, a non-transitory computer readable medium stores software instructions that when executed by one or more processors of an AF, cause the AF to: detect a handover required condition; and notify, directly or via a NEF, an AMF that a handover is required.

According to another aspect of the present disclosure, a computer program comprises instructions which, when executed by at least one processor of an AF, cause the at least one processor to carry out the steps of: detecting a handover required condition; and notifying, directly or via a NEF, an AMF that a handover is required.

According to another aspect of the present disclosure, a method for AFs operating in a telecommunications network to request handover comprises, at a NEF: receiving, from an AF, a handover required request; querying a Unified Data Management (UDM) node, for an identity of a Serving AMF (S-AMF); receiving, from the UDM node, the identity of the S-AMF; and sending, to the identified S-AMF, the handover required request.

In some embodiments, the method further comprises, prior to querying the UDM node, validating the handover required request received from the AF.

In some embodiments, validating the handover required request received from the AF comprises using a UE reachability procedure to validate rights of the AF.

According to another aspect of the present disclosure, a NEF for operating in a telecommunications network is adapted to: receive, from an AF, a handover required request; query a UDM node, for an identity of a S-AMF; receive, from the UDM node, the identity of the S-AMF; and send, to the identified S-AMF, the handover required request.

In some embodiments, the NEF is further operable to, prior to querying the UDM node, validate the handover required request received from the AF.

In some embodiments, validating the handover required request received from the AF comprises using a UE reachability procedure to validate rights of the AF.

According to another aspect of the present disclosure, a NEF for operating in a telecommunications network comprises one or more modules operable to: receive, from an AF, a handover required request; query a UDM node, for an identity of a S-AMF; receive, from the UDM, the identity of the S-AMF; and send, to the identified S-AMF, the handover required request.

In some embodiments, the one or more modules are further operable to, prior to querying the UDM node, validate the handover required request received from the AF.

In some embodiments, validating the handover required request received from the AF comprises using a UE reachability procedure to validate rights of the AF.

According to another aspect of the present disclosure, a non-transitory computer readable medium stores software instructions that when executed by one or more processors of a NEF, cause the NEF to: receive, from an AF, a handover required request; query a UDM node, for an identity of a S-AMF; receive, from the UDM, the identity of the S-AMF; and send, to the identified S-AMF, the handover required request.

In some embodiments, the instructions further cause the NEF to, prior to querying the UDM node, validate the handover required request received from the AF.

In some embodiments, validating the handover required request received from the AF comprises using a UE reachability procedure to validate the rights of the AF.

According to another aspect of the present disclosure, a computer program comprises instructions which, when executed by at least one processor of a NEF, cause the at least one processor to carry out the steps of: receiving, from an AF, a handover required request; querying a UDM node, for the identity of a S-AMF; receiving, from the UDM node, the identity of the S-AMF; and sending, to the identified S-AMF, the handover required request.

In some embodiments, the instructions further cause the NEF to, prior to querying the UDM node, validate the handover required request received from the AF.

In some embodiments, validating the handover required request received from the AF comprises using a UE reachability procedure to validate rights of the AF.

According to another aspect of the present disclosure, a method for AFs operating in a telecommunications network to request handover comprises, at an AMF: receiving, from an AF directly or via a NEF, a handover required request; and processing the received handover required request.

According to another aspect of the present disclosure, an AMF is adapted to: receive, from an AF directly or via a NEF, a handover required request; and process the received handover required request.

According to another aspect of the present disclosure, an AMF comprises one or more modules operable to: receive, from an AF directly or via a NEF, a handover required request; and process the received handover required request.

According to another aspect of the present disclosure, a non-transitory computer readable medium stores software instructions that when executed by one or more processors of an AMF, cause the AMF to: receive, from an AF directly or via a NEF, a handover required request; and process the received handover required request.

According to another aspect of the present disclosure, a computer program comprises instructions which, when executed by at least one processor of an AMF, cause the at least one processor to carry out the steps of: receiving, from an AF directly or via a NEF, a handover required request; and processing the received handover required request.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of a cellular communications network according to some embodiments of the present disclosure;

FIG. 2A illustrates a wireless communication system represented as a Fifth Generation (5G) network architecture composed of core Network Functions (NFs), where interaction between any two NFs is represented by a point-to-point reference point/interface;

FIG. 2B illustrates a 5G network architecture using service-based interfaces between the NFs in the control plane, instead of the point-to-point reference points/interfaces used in the 5G network architecture of FIG. 2A;

FIG. 3 illustrates conventional signaling messages by which an Applications Function (AF) can request traffic steering, but not handover, in a 5G network;

FIG. 4 illustrates an exemplary client device configured to allow a native or external application to request client device handover according to some embodiments of the present disclosure;

FIG. 5 illustrates signaling messages exchanged in an exemplary process by which a native application within a client device may request client device handover according to some embodiments of the present disclosure;

FIG. 6 illustrates exemplary signaling messages exchanged in an exemplary process by which an external application connected to a client device may request client device handover according to some embodiments of the present disclosure;

FIG. 7 illustrates signaling messages exchanged in an exemplary process by which an application native within or external to a client device is certified by the network to request client device handover according to some embodiments of the present disclosure;

FIG. 8 illustrates signaling messages exchanged in an exemplary process by which an AF may request client device handover according to some embodiments of the present disclosure;

FIG. 9 is a schematic block diagram of a radio access node according to some embodiments of the present disclosure;

FIG. 10 is a schematic block diagram that illustrates a virtualized embodiment of the radio access node of FIG. 9 according to some embodiments of the present disclosure;

FIG. 11 is a schematic block diagram of the radio access node of FIG. 9 according to some other embodiments of the present disclosure;

FIG. 12 is a schematic block diagram of a client device, such as a User Equipment (UE), according to some embodiments of the present disclosure;

FIG. 13 is a schematic block diagram of the client device of FIG. 12 according to some other embodiments of the present disclosure;

FIG. 14 illustrates a telecommunication network connected via an intermediate network to a host computer in accordance with some embodiments of the present disclosure;

FIG. 15 is a generalized block diagram of a host computer communicating via a base station with a client device over a partially wireless connection in accordance with some embodiments of the present disclosure;

FIG. 16 is a flowchart illustrating a method implemented in a communication system in accordance with one embodiment of the present disclosure;

FIG. 17 is a flowchart illustrating a method implemented in a communication system in accordance with one embodiment of the present disclosure;

FIG. 18 is a flowchart illustrating a method implemented in a communication system in accordance with one embodiment on the present disclosure; and

FIG. 19 is a flowchart illustrating a method implemented in a communication system in accordance with one embodiment of the present disclosure.

### DETAILED DESCRIPTION

Methods and systems by which online services applications, browsers or external devices can request client device handover are herein provided. The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

### Introduction

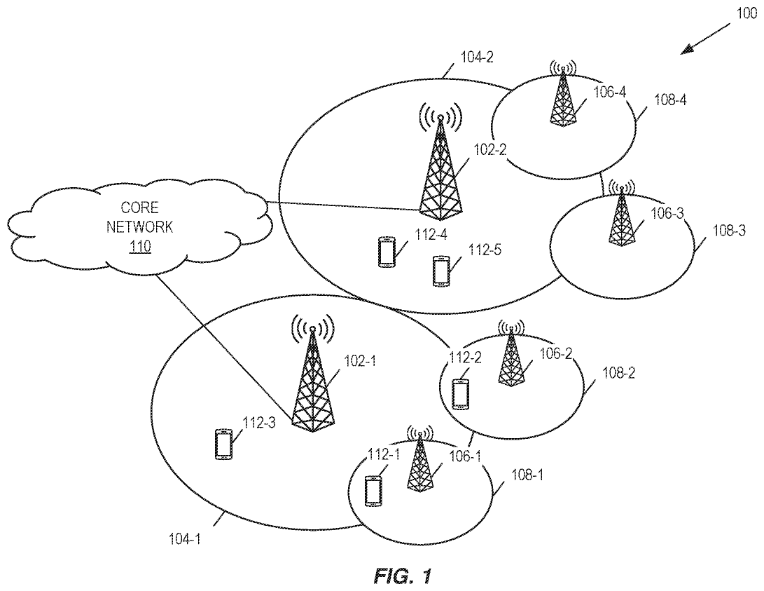

FIG. 1 illustrates one example of a cellular communications network 100 according to some embodiments of the present disclosure. In the embodiments described herein, the cellular communications network 100 is a 5G NR network. In this example, the cellular communications network 100 includes base stations 102-1 and 102-2, which in LTE are referred to as eNBs and in 5G NR are referred to as gNBs, controlling corresponding macro cells 104-1 and 104-2. The base stations 102-1 and 102-2 are generally referred to herein collectively as base stations 102 and individually as base station 102. Likewise, the macro cells 104-1 and 104-2 are generally referred to herein collectively as macro cells 104 and individually as macro cell 104. The cellular communications network 100 also includes a number of low power nodes 106-1 through 106-4 controlling corresponding small cells 108-1 through 108-4. The low power nodes 106-1 through 106-4 can be small base stations (such as pica or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The base stations 102 (and optionally the low power nodes 106) are connected to a core network 110.

The base stations 102 and the low power nodes 106 provide service to wireless devices 112-1 through 112-5 in the corresponding cells 104 and 108. The wireless devices 112-1 through 112-5 are generally referred to herein collectively as wireless devices 112 and individually as wireless device 112. The wireless devices 112 are also sometimes referred to herein as UEs 112 or client devices 112.

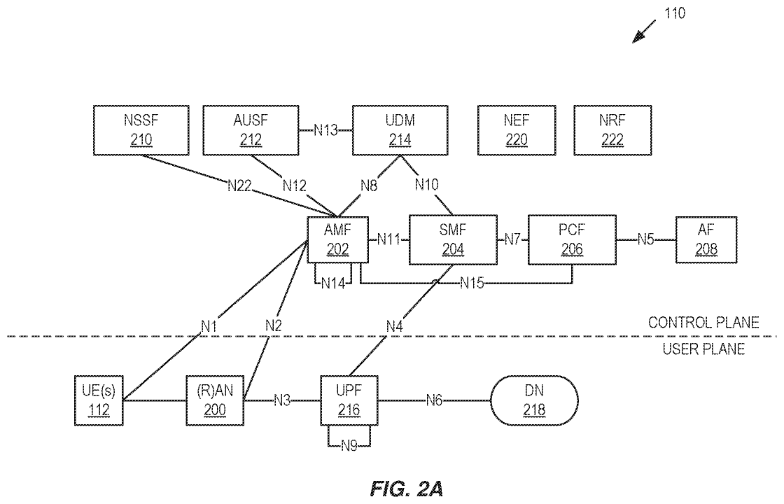

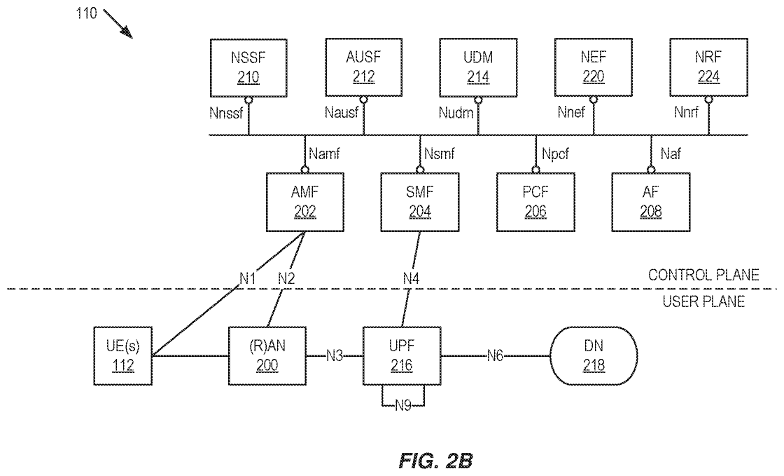

FIG. 2A illustrates a wireless communication system represented as a 5G network architecture composed of core Network Functions (NFs), where interaction between any two NFs is represented by a point-to-point reference point/interface. FIG. 2A can be viewed as one particular implementation of the cellular communications network 100 of FIG. 1.

Seen from the access side the 5G network architecture shown in FIG. 2A comprises a plurality of UEs 112 connected to either a Radio Access Network (RAN) or an Access Network (AN). A node that may be either a RAN or an AN may be referred to as a “(R)AN” 200 and labeled as such in FIG. 2A. For brevity, hereinafter, the term “RAN” will be understood to refer to either a RAN or an AN unless otherwise specified as being exclusively referring to a RAN. Typically, a RAN 200 comprises base stations 102, such as eNBs, gNBs, or similar. Each client device 112 may also be connected to a Core Access and Mobility Management Function (AMF) 202. Seen from the core network 110 side, the 5G core NFs shown in FIG. 2A include a Session Management Function (SMF) 204, a Policy Control Function (PCF) 206, and an Application Function (AF) 208, a Network Slice Selection Function (NSSF) 210, an Authentication Server Function (AUSF) 212, and a Unified Data Management (UDM) function 214. The network architecture illustrated in FIG. 2A also includes a User Plane Function (UPF) 216 which operates as a data conduit to a Data Network (DN) 218. The network architecture illustrated in FIG. 2A also includes a Network Exposure Function (NEF) 220, and a Network Repository Function (NRF) 222, which can interact with all 5G core NFs depicted in FIG. 2A as necessary.

Reference point representations of the 5G network architecture are used to develop detailed call flows in the normative standardization. The N1 reference point is defined to carry signaling between the client device 112 and AMF 202. The reference points for connecting between the RAN 200 and AMF 202 and between the RAN 200 and UPF 216 are defined as N2 and N3, respectively. There is a reference point, N11, between the AMF 202 and SMF 204, which implies that the SMF 204 is at least partly controlled by the AMF 202. N4 is used by the SMF 204 and UPF 216 so that the UPF 216 can be set using the control signal generated by the SMF 204, and the UPF 216 can report its state to the SMF 204. N9 is the reference point for the connection between different UPFs 216, and N14 is the reference point connecting between different AMFs 202, respectively. N15 and N7 are defined since the PCF 206 applies policy to the AMF 202 and SMF 204, respectively. N12 is required for the AMF 202 to perform authentication of the client device 112. N8 and N10 are defined because the subscription data of the client device 112 is required for the AMF 202 and SMF 204.

The 5G core network 110 aims at separating user plane and control plane. The user plane carries user traffic while the control plane carries signaling in the network. In FIG. 2A, the UPF 216 is in the user plane and all other NFs, i.e., the AMF 202, SMF 204, PCF 206, AF 208, AUSF 212, and UDM function 214, are in the control plane. Separating the user and control planes guarantees each plane resource to be scaled independently. It also allows the UPFs 216 to be deployed separately from control plane functions in a distributed fashion. In this architecture, the UPFs 216 may be deployed very close to the UEs 112 to shorten the Round Trip Time (RTT) between the UEs 112 and the DN 218 for some applications requiring low latency.

The core 5G network architecture is composed of modularized functions. For example, the AMF 202 and SMF 204 are independent functions in the control plane. Separated AMFs 202 and SMFs 204 allow independent evolution and scaling. Other control plane functions like the PCF 206 and AUSF 212 can be separated as shown in FIG. 2A. Modularized function design enables the 5G core network 110 to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs 216.

FIG. 2B illustrates a 5G network architecture using service-based interfaces between the NFs in the control plane, instead of the point-to-point reference points/interfaces used in the 5G network architecture of FIG. 2A. However, the NF's described above with reference to FIG. 2A correspond to the NFs shown in FIG. 2B. The service(s) etc. that a NF provides to other authorized NFs can be exposed to the authorized NFs through the service-based interface. In FIG. 2B the service based interfaces are indicated by the letter “N” followed by the name of the NF, e.g., Namf for the service based interface of the AMF 202, Nsmf for the service based interface of the SMF 204, etc.

Some properties of the NFs shown in FIGS. 2A and 2B may be described in the following manner. The AMF 202 provides UE-based authentication, authorization, mobility management, etc. A UE even using multiple access technologies is basically connected to a single AMF 202 because the AMF 202 is independent of the access technologies. The SMF 204 is responsible for session management and allocates Internet Protocol (IP) addresses to the UEs 112. It also selects and controls the UPF 216 for data transfer. If a UE 112 has multiple sessions, different SMFs 204 may be allocated to each session to manage them individually and possibly provide different functionalities per session. The AF 208 provides information on the packet flow to the PCF 206 responsible for policy control in order to support Quality of Service (QoS). Based on the information, the PCF 206 determines policies about mobility and session management to make the AMF 202 and SMF 204 operate properly. The AUSF 212 supports authentication function for the UEs 112 or similar and thus stores data for authentication of the UEs 112 or similar while the UDM function 214 stores subscription data of the UE 112. The DN 218, not part of the 5G core network 110, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

In current 5G Core (5GC)/NR specifications, network elements such as a Remote Radio Unit (RRU), a Base Band Unit (BBU), an AMF, and a Network Data Analytics Function (NWDAF), are the network elements involved handover procedures. Similar to previous cellular technologies such as LTE, Third Generation (3G), Second Generation (2G), and so on, only network functions within the operator network have any influence to trigger a handover process after exchanging signaling with UE being served by the network.

However, “third party” network elements—defined herein as network elements that are outside of a network operator's domain and are thus not considered part of the core network 110—may have access to a wealth of information that could provide valuable insight into network conditions, both instantaneous conditions and long term trends. For example, AFs owned and/or controlled by service providers such as search engines, social media platforms, etc., often have detailed user data that includes not only QoS information but also Quality of Experience (QoE). Such data may be representative of a large number of users operating a large variety of types of client devices under a large variety of conditions. Although such information could be enormously valuable to the handover decision-making process, there is currently no mechanism for such information to be used for such a purpose.

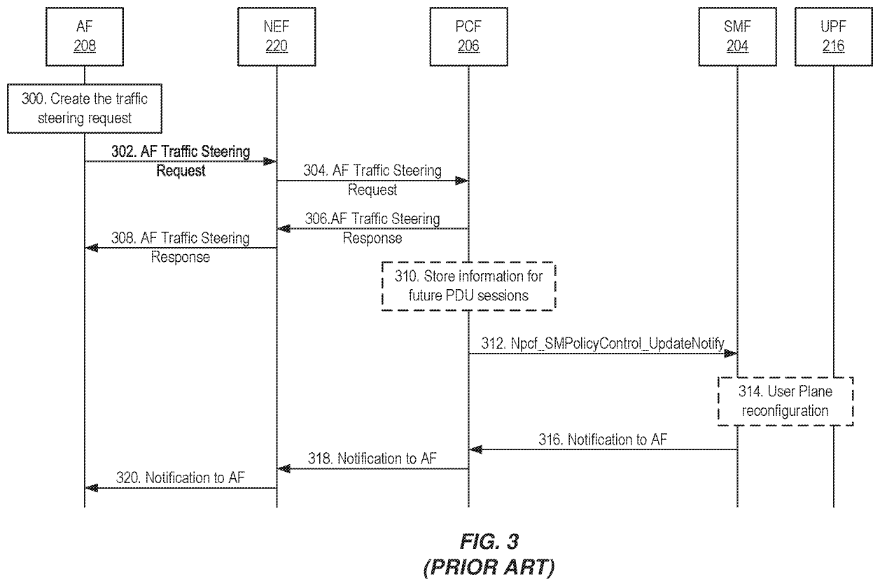

Current 5G specifications define a process by which an AF can request traffic steering: such capability is documented in 3GPP Technical Specification (TS) 23.502, Version 15.1.0, item 4.3.6.2. While a request for traffic steering could eventually trigger the need for a handover, this process is not yet a direct handover request. A simplified version of this process is illustrated in FIG. 3.

FIG. 3 illustrates conventional signaling messages by which an AF 208 can request traffic steering, but not handover, in a 5G network.

At step 300, the AF 208 creates a traffic steering request. At step 302, the AF 208 sends the traffic steering request to the NEF 220. At step 304, the NEF 220 forwards the traffic steering request to the PCF 206. At step 306, the PCF 206 sends a traffic steering response to the NEF 220. At step 308, the NEF 220 sends the traffic steering response to the AF 208.

At step 310, the PCF 206 optionally stores information for future Protocol Data Unit (PDU) sessions. At step 312, the PCF 206 notifies the SMF 204 of a policy control update. At step 314, the SMF 204 and the UPF 216 perform user plane reconfiguration, and at step 316, notify the PCF 206 of the result. At step 318, the PCF 206 forwards this result to the NEF 220, and at step 320, the NEF 220 forwards this result to the AF 208.

As the call flow in FIG. 3 shows, an AF 208 can issue a traffic steering request that can influence the SMF 204 routing to a nearby UPF 216, for example, instead of a centralized UPF 216, which allows online services AF backends to call for Local Breakout (LBO) to reduce latency, one of the key requirements of 5G use cases.

However, the conventional call flow shown in FIG. 3 can't influence SMF 204 routing over the AMFs 202, which means that it can't influence AMF handover procedures. Without this ability to influence AMF handover procedures, the AF 208 is unable to influence the mobility trajectory and is thus unable to direct the client device onto the best cells, e.g., to cells that have a better QoE or that have some other characteristic desired by a particular application or application function backend.

This inability has significant disadvantages because some online services providers possess very good information on the possibility of customer experience on nearby/neighbor cells but conventional networks provide no mechanism by which these online services providers could contribute directly to the mobility trajectory. In short: for conventional networks, only Mobile Network Operators (MNOs) can trigger handover requests.

Thus, methods and systems by which online services applications, browsers, or external devices can request client device handover are herein provided. The methods and systems presented herein provide a solution by which entities outside of the network operator's domain, such as online services providers, Over-the-Top (OTT) providers, Enterprise services provides, or other entities can request handover. In some embodiments, the network operator would still maintain the ultimate decision and may reject these handover requests at their discretion.

As used herein, the terms “a request for handover” and “a handover request” are synonymous, and may refer to any request that is related to the handover process, including, but not limited to, a request for a handover, a request to trigger a handover, a request for a request for a handover, and so on. In a handover operation, the control plane or user plane data path may move, e.g., from one RAN to another, from one AMF to another, and so on. This is referred to as a move from a Source RAN (S-RAN), to a Target RAN (T-RAN). Likewise, a handover may involve a change from a Serving AMF (S-AMF) to a Target AMF (T-AMF), etc. Thus, as used herein, the prefix “S-” indicates a source node and the prefix “T-” indicates a target node.

Handover requests may come from an application running on a client device 112 or from an AF 208. Each of these will now be described in turn.

### Handover Requested By Client Device Application

In one solution of the present disclosure, applications within a client device, referred to herein as “native applications,” or connected to the client device via a wired or wireless interface, referred to herein as “external applications,” may make handover requests. As used herein, the term “client device application” may refer to a native application, an external application, or both, unless specifically stated to refer to a particular one or the other. Example applications include, but are not limited to, browsers, social media applications, and other programs.

The signal flow may be generically described as going from a client device application, through a client device Application Programming Interface (API) layer, to a client device modem, which transmits the handover request to the telecommunications network 100 that is currently serving the client device 112.

This solution may require modification to the existing client device ecosystem but does not require a change to existing telecommunications standards. This solution provides business opportunities, such as licensing agreements with UE modem suppliers, UE device suppliers, connected devices that use a UE as a hub, and UE browsers or other applications. This solution allows elements outside of a RAN 200, base station 102, eNB, and the like, to trigger a handover process. The handover process may be triggered by sending a request to trigger this process, e.g., by sending a “handover required” message.

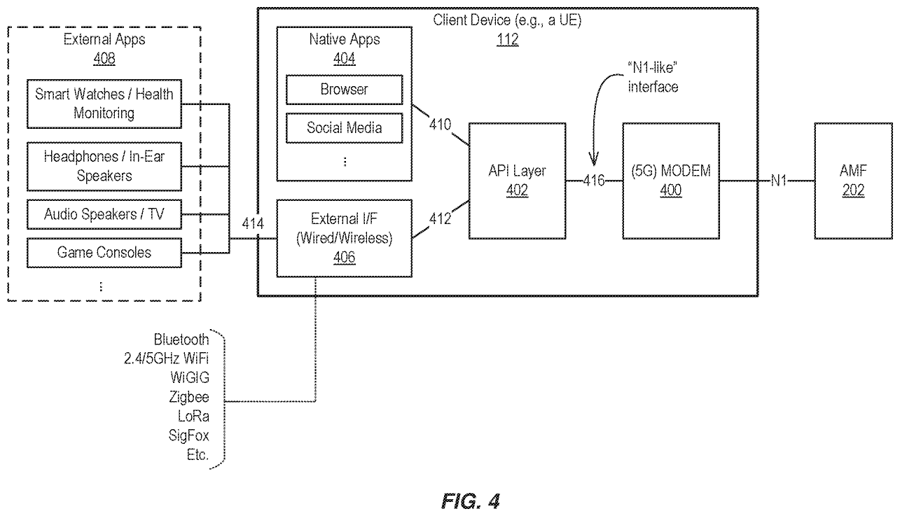

FIG. 4 illustrates an exemplary client device 112 configured to allow a native application or external application to request client device handover according to some embodiments of the present disclosure. Examples of client devices 112 include, but are not limited to, a UE, a Customer Premises Equipment (CPE), an automobile, an Unmanned Aerial Vehicle (UAV), an airplane, a robot, machinery, an appliances, a vehicle, or any other entity that contains a 5G modem and that may be capable of (or would benefit from) having some input into the handover process.

In the embodiment illustrated in FIG. 4, the client device 112 includes a modem 400, which it uses to connect to the cellular communications network 100. In the embodiment illustrated in FIG. 4, the client device 112 communicates with an AMF 202 via the N1 interface. In some embodiments, the modem 400 is a 5G modem. In some embodiments, the modem 400 may support 5G, LTE, or other networks.

In the embodiment illustrated in FIG. 4, the client device 112 also includes one or more APIs, which are located in an API layer 402. The API layer 402 exposes the “handover required” and other N2 capabilities to applications within the client device 112 and also to applications connected to the client device 112, such as within external devices that are using the client device 112 as a hub or other type of connection into the cellular network.

In some embodiments, the API layer 402 may support the following parameters between the client device applications and the API layer 402:
A Request Identifier (ID) (e.g., to identify the application making the request); and
Cause of Handover Required (e.g., a reason for requesting the handover, such as an adjustment of QoS, QoE, or other aspect).
   In some embodiments, the API layer 402 validates the Request ID to verify that it is approved to use this modem 400. This may be accomplished using pre-approved certificates exchanged between an application backend (e.g., the AF 208) and the appropriate authorization network functions within the core network 110 (e.g., the UDM function 214). After the API layer 402 approves the transaction, it will pass the Request ID and Cause of Handover Required to the 5G modem 400 that communicates with the S-RAN.

In the embodiment illustrated in FIG. 4, the API layer 402 provides APIs by which native applications 404 and external applications 408 may request a trigger in a handover process.

For example, the client device 112 may have a wired connection to audio speakers, a television, or other appliance. Likewise, the client device 112 may be connected wirelessly to different kinds of devices, including smart watches or health monitoring devices, audio speakers, a television, headphones or in-ear speakers, game consoles, etc. These examples are illustrative and not limiting. In some embodiments, the wireless interface may support one or more wireless protocols, including but not limited to Bluetooth, 2.4/5 Gigahertz (GHz) WiFi, WiGIG, Zigbee, Long Range (LoRa) radio, SigFox, or any type of low power type of wireless communication, etc. In this manner, external devices may be connected to the 5G network through the client device 112, via cable, wire, or wireless link to the client device 112, e.g., the client device 112 operates as a “hub.”

In some embodiments, the API layer 402 is middleware that resides on the client device 112 and is conceptually located between the modem 400 and the native applications 404 and/or external applications 408. In some embodiments, the API layer 402 exposes handover and other N2 interface capabilities to the native and external applications 404 and 408, so that these applications 404 and 408 can influence the handover process. As will be described in more detail below, native applications 404 and external applications 408 may request to trigger the handover process, e.g., ultimately causing the client device 112 to issue a “handover required” or other message to the AMF 202.

In some embodiments, the network slice selection process may be exposed to the native and external applications 404 and 408 through the API layer 402 via the creation or modification of logical and/or physical interfaces within the UE 112 or other client device architecture. In the embodiment illustrated in FIG. 4, a new interface 410 is defined between the API layer 402 and native applications 404; a new interface 412 is defined between the API layer 402 and an external interface 406; and a new interface 414 is defined between the external interface 406 and external applications 408. In some embodiments, one or more of the new interfaces 410, 412, and 414 may comprise a Representational State Transfer (REST) API to be used during the client device 112 call flows when a native application 404 requests to trigger a handover.

In some embodiments, an interface 416 between the API layer 402 and the modem 400 is modified to allow the native and external applications 404 and 408 to specify handover-related parameters to be included within the “handover required” or other message to be sent via the N1 interface. For this reason, the interface 416 may be referred to as being “N1-like.” Therefore, the interface 416 may be referred to herein as the N1 interface 416. An N1 interface between a UE and an AMF as defined in the 5G standards doesn't have the capability to allow UEs to send “handover required” messages (under current standards, a UE can only send signal level monitoring information, which gives only a partial picture of network performance and quality of end user experience), and in these embodiments, the N1 interface is enhanced to support having internal and external UE applications making “handover required” or similar requests.

It should be noted that some of the enhanced features of the client device 112 do not require any modification to the existing N1 interface 416, but instead reuse current conventional N1 capabilities, with the caveat that the conventional messages sent over the N1 interface 416 now take into account the information provided to the API layer 402 via the new interfaces410, 412, and 414. For example, in some embodiments, messages sent by the modem 400 to the AMF 202 via the N1 interface 416 may include handover-related parameters supplied by the native applications 404 or external applications 408.

In other embodiments, the existing N1 interface 416 may be enhanced. For example, in some embodiments, the existing N1 interface 416 may be extended to allow the API layer 402 to be synchronized with 5G core systems on which the native applications 404 and external applications 408 are authorized to participate in the handover process. In some embodiments, the existing N1 layer may be extended so as to provide the modem 400 with information for the modem 400 to use to allow a request from a native application 404 or external application 408, to certify that the native application 404 or external application 408 may issue such a request, and so on.

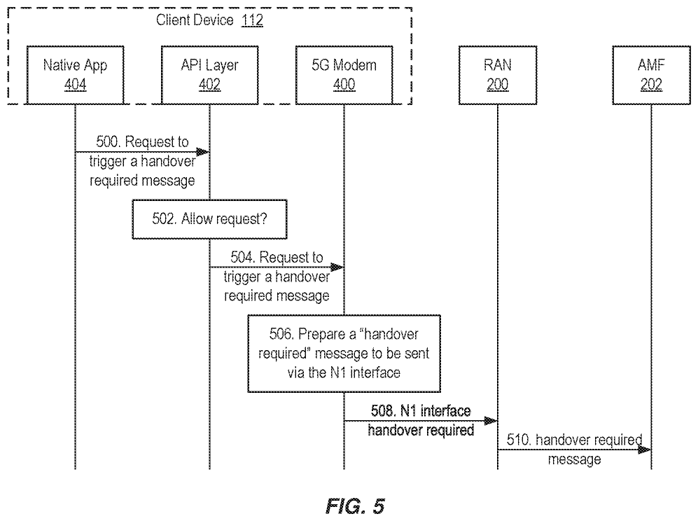

FIG. 5 illustrates signaling messages exchanged in an exemplary process by which a native application 404 within a client device 112 may request client device handover according to some embodiments of the present disclosure.

At step 500, the native application 404 sends to the API layer 402 a request to trigger a “handover required” message.

At step 502, the API layer 402 first determines whether or not to allow the request. In the embodiment illustrated in FIG. 5, the request is allowed. In alternative embodiments, the request may be denied. In some embodiments, this step may be omitted entirely, i.e., the API layer 402 may always accept such requests.

At step 504, the API layer 402 forwards the request to the 5G modem 400.

At step 506, the 5G modem 400 prepares a “handover required” message to be sent via the N1 interface 416.

At step 508, the 5G modem 400 sends the prepared message over the N1 interface 416 to a S-RAN, e.g., the RAN 200 in FIG. 5.

At step 510, the RAN 200 forwards the handover required message to a S-AMF, e.g., the AMF 202 in FIG. 5.

The handover procedure between an S-RAN and an S-AMF remains the same. When an S-RAN is a Next Generation RAN (NG-RAN), for example, the N2 parameters may include the 5G Globally Unique Temporary Identity (5G-GUTI), Selected Public Land Mobile Network (PLMN) ID, location information, Radio Access Technology (RAT) type, and Establishment cause. If the UE 112 is in Connection Management (CM)-IDLE state, the RAN 200 obtains the 5G-GUTI via a Radio Resource Control (RRC) procedure, and the

RAN 200 selects the AMF 202 according to 5G-GUTI. The location information and RAT type relates to the cell in which the UE 112 is camping. Based on the PDU Session status, the AMF 202 may initiate a PDU Session Release procedure in the network for the PDU Sessions, the PDU Session ID(s) of which were indicated by the UE 112 as not available.

An example handover required message from the RAN 200 to the AMF 202 may include parameters such as, but not limited to, Target ID, Source to Target transparent container, an SM N2 information list, and PDU Session IDs. In one embodiment:
The Target ID includes the selected PLMN ID;
The Source to Target transparent container includes RAN information created by the S-RAN to be used by the T-RAN, and is transparent to 5GC;
All PDU Sessions handled by S-RAN (i.e., all existing PDU Sessions with active user plane connections) shall be included in the Handover Required message, indicating which of those PDU Session(s) are requested by S-RAN to handover;
The SM N2 information list also includes Direct Forwarding Path Availability, and identifies which QoS Flows are subject to data forwarding;
Direct Forwarding Path Availability indicates whether direct forwarding is available from the S-RAN to the T-RAN. This indication from S-RAN can be based on, e.g., the presence of IP connectivity and security association(s) between the S-RAN and the T-RAN.

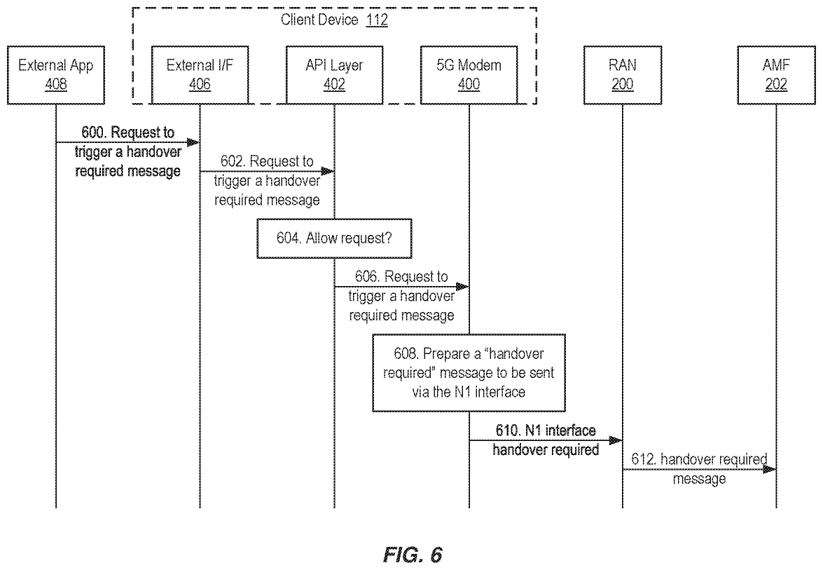

FIG. 6 illustrates exemplary signaling messages exchanged in an exemplary process by which an external application 408 connected to a client device 112 may request client device handover according to some embodiments of the present disclosure.

At step 600, the external application 408 sends to the client device 112 a request to trigger a “handover required” message, which is received via the external interface 406.

At step 602, the request is forwarded by the external interface 406 to the API layer 402.

At step 604, the API layer 402 determinates whether or not to allow the request from the external application 408. In the embodiment illustrated in FIG. 6, the request is allowed. In an alternative embodiment the request may be denied. In some embodiments this step may be omitted entirely, i.e., the API layer 402 may always accept such requests from the external applications 408.

At step 606, the API layer 402 forwards the request to the 5G modem 400.

At step 608, the 5G modem 400 prepares a “handover required” message to be sent via the N1 interface 416.

At step 610, the 5G modem 400 sends the prepared message over the N1 interface 416 to the RAN 200.

At step 612, the RAN 200 forwards the handover required message to a S-AMF, which in the embodiment illustrated in FIG. 6 is the AMF 202.

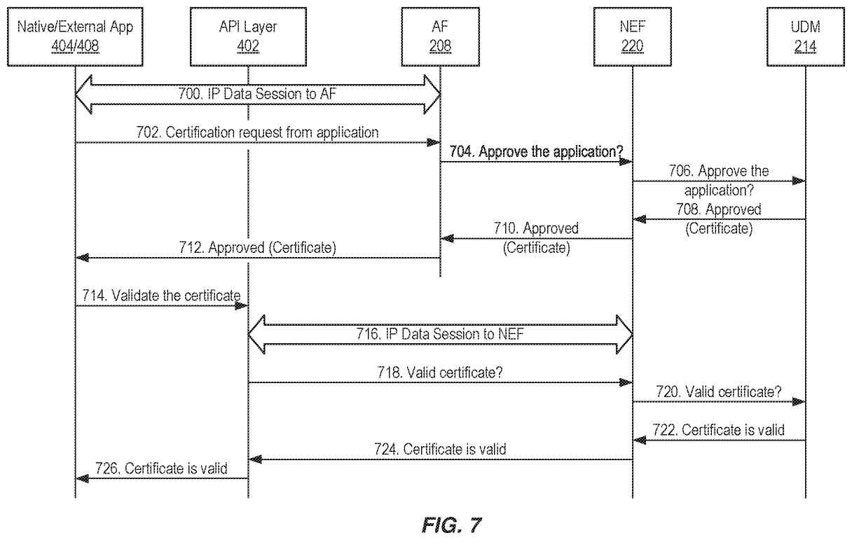

FIG. 7 illustrates signaling messages exchanged in an exemplary process by which a native application 404 or external application 408 is certified by the network to request client device handover according to some embodiments of the present disclosure. In the embodiment illustrated in FIG. 7, the requesting native application 404 or external application 408 already has a data session 700 with an AF 208 (e.g., an OTT backend server).

At step 702, a request is sent from a new native application 404 or external application 408 to the associated application backend, which in FIG. 7 is the AF 208. In the embodiment illustrated in FIG. 7, the AF 208 needs to query an entity that certifies applications to determine whether the requesting native application 404 or external application 408 is certified. In the embodiment illustrated in FIG. 7, the UDM function 214 performs this function, but in alternative embodiments, this function may be performed by other operator network nodes, such as a PCF 206, a Home Subscriber Service (HSS), or other database node. In the embodiment illustrated in FIG. 7, the AF 208 is outside of the operator network; to get to the UDM function 214, the AF 208 must go through a NEF 220 to reach operator network nodes such as the UDM function 214.

At step 704, therefore, the AF 208 sends to the NEF 220 a message asking to approve the new application.

At step 706, the NEF 220 forwards the query to the UDM function 214.

At step 708, the UDM function 214 approves the new native application 404 or external application 408 and provides to the NEF 220 a certificate to be used by the client device 112. In some embodiments, the approval includes a certificate to match a certificate of the API layer 402.

At step 710, the NEF 220 forwards the certificate to the AF 208.

At step 712, the AF 208 forwards the certificate to the now-certified native application 404 or external application 408. Thus, the application goes through the AF 208 to get certified. Once certified, the application then communicates with the NEF 220 directly to validate the certificate.

At step 714, the native application 404 or external application 408 sends to the API layer 402 a request to validate the certificate. This request may include the certificate to be validated or may contain information that otherwise identifies the certificate to be validated. The API layer 402 communicates with the NEF 220 via an IP data session 716.

At step 718, the API layer 402 requests that the NEF 220 validate the certificate. This request may include the certificate to be validated or may contain information that otherwise identifies the certificate to be validated.

At step 720, the NEF 220 queries the UDM function 214 to validate the certificate.

At step 722, the UDM function 214 notifies the NEF 220 that the certificate is valid.

At step 724, the NEF 220 forwards this notification to the API layer 402.

At step 726, the API layer 402 forwards this notification to the application.

In some embodiments, the native application 404 or external application 408 will then include the certificate when it makes handover-related request. In some embodiments, the API layer 402 and/or the 5G modem 400 will maintain copies of the received certificates and will use them to validate requests from applications. For example, a 5G modem 400 may allow transmission of a request received from a native application 404 or external application 408 only if that request contains a certificate that matches one of the certificates maintained by the 5G modem 400. In other embodiments, the API layer 402 and/or the 5G modem 400 may operate in an open, non-restrictive mode, e.g., allowing any request from a native application 404 or external application 408 to pass through to the network without restriction. In still other embodiments, the API layer 402 and/or the 5G modem 400 may impose limited restrictions on what requests from native applications 404 or external applications 408 may be allowed out onto the network. The same principles described above may apply to restrict (or not restrict) incoming traffic from the network to the client device 112, as well.

In some embodiments, the measurement reporting interfaces between a client device 112 and a RAN 200 are unchanged. As can be seen in FIGS. 5 and 6, the proposal is very simple, i.e., the 5G/LTE modem 400 is granted access to N2-Handover Required capability. Then, instead of just reporting the measurements, the UE 112 could send a Handover Required message to an S-RAN (e.g., the RAN 200 of FIGS. 5 and 6) via an expanded N1. For example, if an Online Service Provider, i.e., an owner of an approved/authorized UE application (e.g., the native application 404 or external application 408 of FIGS. 5 and 6), would like to force the specific UE application to use a RAT (Cell ID) that supports higher throughput, but in that location, the S-RAN with the higher quality signal is a low bandwidth cell, in this case the UE application could request a “forced” handover required to a higher throughput S-RAN. The S-RAN could then evaluate the request coming from the UEs and, in the case the request is approved, the S-RAN could propagate the Handover Required to the S-AMF and the call flows would remain the same from this point forward. An example of evaluation criteria could be the validation of the availability of higher bandwidth S-RAN cells in the area of the UE/CPE with minimum signal levels required.

### Handover Requested By Third Party Application Function

In another solution of the present disclosure, an Online Services Application Function backend may make handover requests. This option requires new call flows and requires approvals from standardization bodies such as 3GPP.

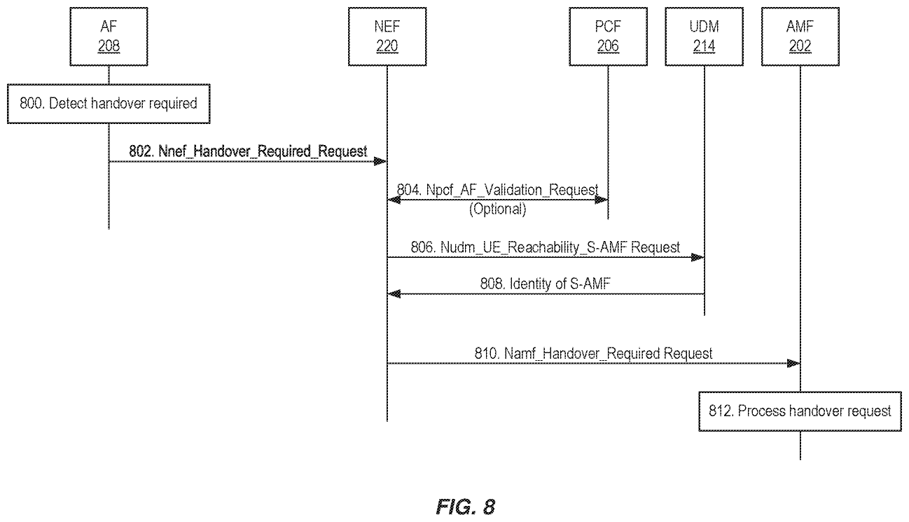

FIG. 8 illustrates signaling messages exchanged in an exemplary process by which an AF 208 may request client device handover according to some embodiments of the present disclosure. In this alternative solution, the Handover Required message to the AMF 202 could be sent by the AF 208 via the NEF 220, in which case a service-based interface towards the AMF 202 would be used—something like the existing service-based interface, Samf—to simulate the N2 interface Handover Required. In this approach, the AMF 202 could be identified by the NEF 220 with help from the UDM function 214, e.g., using the existing 3GPP UE reachability procedure to validate the rights of external requestors.

Thus, in the embodiment illustrated in FIG. 8, at step 800, the AF 208 detects that a handover is required. Thus, at step 802, the AF 208 sends a handover required request to the NEF 220. At step 804, the NEF 220 engages the PCF 206 to validate the request, then uses the above-mentioned reachability procedure with the UDM function 214 to identify the pertinent S-AW, shown as step 806 (i.e., the NEF 220 requests the identity of the AMF 202) and step 808 (i.e., the NEF 220 receives the identity of the AMF 202). At step 810, the NEF 220 then sends the handover request to the identified AMF 202. At step 812, the AMF 202 processes the received handover request.

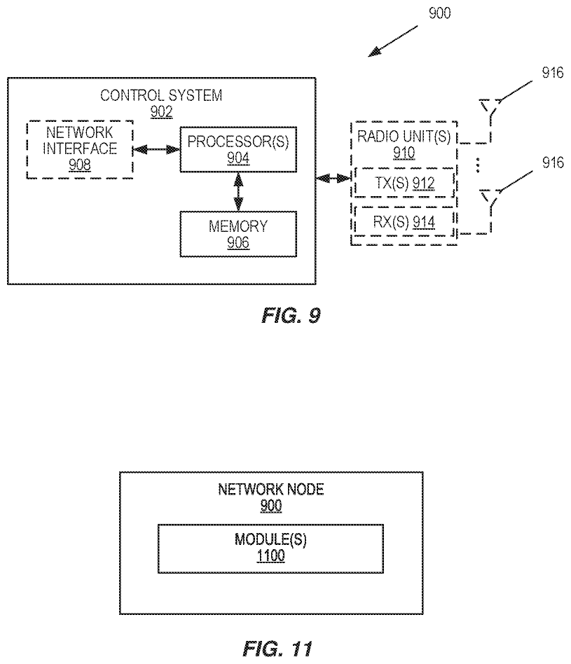

FIG. 9 is a schematic block diagram of a radio access node 900 according to some embodiments of the present disclosure. The radio access node 900 may be, for example, a base station 102 or low power node 106. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the radio access node 900 includes one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a radio access node 900 as described herein. In some embodiments, the function(s) are implemented in software that is stored, e.g., in the memory 906 and executed by the one or more processors 904.

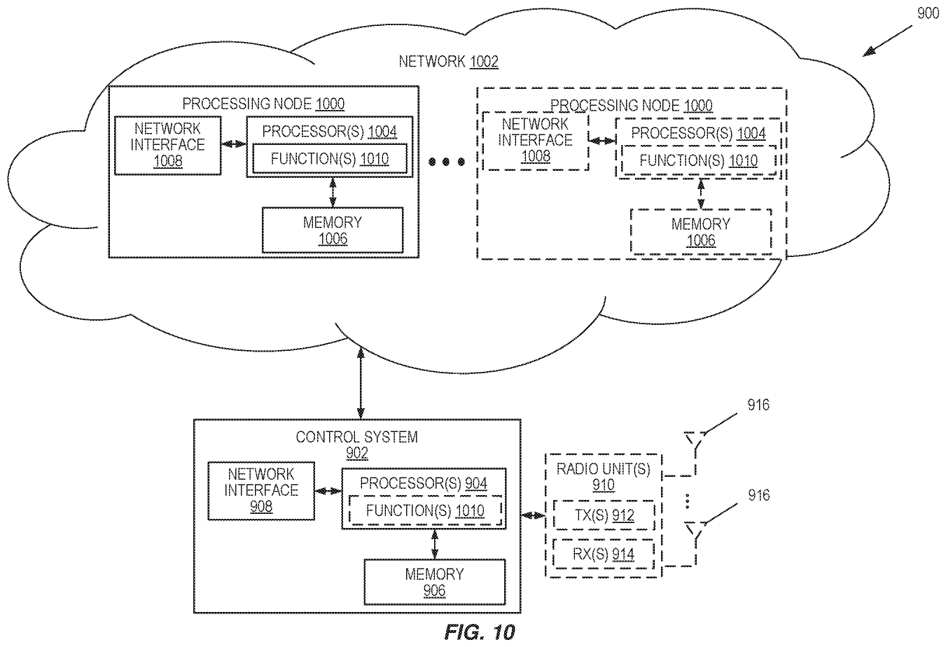

FIG. 10 is a schematic block diagram that illustrates a virtualized embodiment of the radio access node 900 according to some embodiments of the present disclosure. This discussion is equally applicable to other types of network nodes. Further, other types of network nodes may have similar virtualized architectures.

As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 includes the control system 902 that includes the one or more processors 904 (e.g., CPUs, ASICs, FPGAs, and/or the like), the memory 906, and the network interface 908 and the one or more radio units 910 that each includes the one or more transmitters 912 and the one or more receivers 914 coupled to the one or more antennas 916, as described above.

The control system 902 is connected to the radio unit(s) 910 via, for example, an optical cable or the like. The control system 902 is connected to one or more processing nodes 1000 coupled to or included as part of a network(s) 1002 via the network interface 908. Each processing node 1000 includes one or more processors 1004 (e.g., CPUs, ASICs, FPGAs, and/or the like), memory 1006, and a network interface 1008.

In this example, functions 1010 of the radio access node 900 described herein are implemented at the one or more processing nodes 1000 or distributed across the control system 902 and the one or more processing nodes 1000 in any desired manner. In some particular embodiments, some or all of the functions 1010 of the radio access node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of radio access node 900 or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein. This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

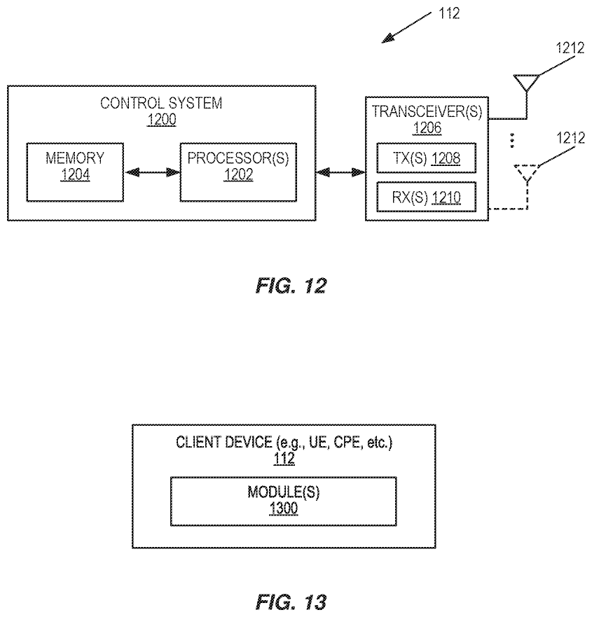

FIG. 12 is a schematic block diagram of a client device 112, such as a UE, Customer Premises Equipment (CPE), or other device, according to some embodiments of the present disclosure. As illustrated, the client device 112 includes a control system 1200 that includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212. The transceiver(s) 1206 includes radio-front end circuitry connected to the antenna(s) 1212 that is configured to condition signals communicated between the antenna(s) 1212 and the processor(s) 1202, as will be appreciated by on of ordinary skill in the art. The processors 1202 are also referred to herein as processing circuitry. The transceivers 1206 are also referred to herein as radio circuitry. In some embodiments, the functionality of the client device 112 described above may be fully or partially implemented in software that is, e.g., stored in the memory 1204 and executed by the processor(s) 1202. Note that the client device 112 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the client device 112 and/or allowing output of information from the client device 112), a power supply (e.g., a battery and associated power circuitry), etc.

In some embodiments, a computer program including instructions which, when executed by at least one processor, causes the at least one processor to carry out the functionality of the client device 112 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the client device 112 according to some other embodiments of the present disclosure. The client device 112 includes one or more modules 1300, each of which is implemented in software. The module(s) 1300 provide the functionality of the client device 112 described herein.

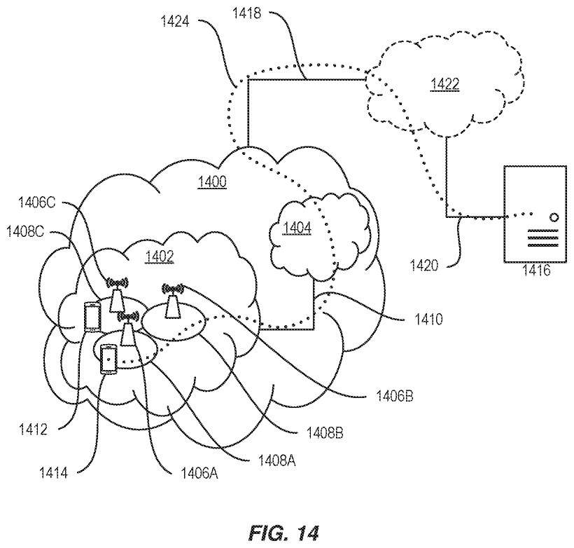

FIG. 14 illustrates a telecommunication network connected via an intermediate network to a host computer in accordance with some embodiments of the present disclosure. With reference to FIG. 14, in accordance with an embodiment, a communication system includes a telecommunication network 1400, such as a 3GPP-type cellular network, which comprises an access network 1402, such as a RAN, and a core network 1404. The access network 1402 comprises a plurality of base stations 1406A, 1406B, 14060, such as Node Bs (NBs), eNBs, gNBs, or other types of wireless Access Points (APs), each defining a corresponding coverage area 1408A, 1408B, 1408C. Each base station 1406A, 1406B, 14060 is connectable to the core network 1404 over a wired or wireless connection 1410. A first UE 1412 located in coverage area 1408C is configured to wirelessly connect to, or be paged by, the corresponding base station 14060. A second UE 1414 in coverage area 1408A is wirelessly connectable to the corresponding base station 1406A. While a plurality of UEs 1412, 1414 are illustrated in this example, the disclosed embodiments are equally applicable to a situation where a sole UE is in the coverage area or where a sole UE is connecting to the corresponding base station 1406.

The telecommunication network 1400 is itself connected to a host computer 1416, which may be embodied in the hardware and/or software of a standalone server, a cloud-implemented server, a distributed server, or as processing resources in a server farm. The host computer 1416 may be under the ownership or control of a service provider, or may be operated by the service provider or on behalf of the service provider. Connections 1418 and 1420 between the telecommunication network 1400 and the host computer 1416 may extend directly from the core network 1404 to the host computer 1416 or may go via an optional intermediate network 1422. The intermediate network 1422 may be one of, or a combination of more than one of, a public, private, or hosted network; the intermediate network 1422, if any, may be a backbone network or the Internet; in particular, the intermediate network 1422 may comprise two or more sub-networks (not shown).

The communication system of FIG. 14 as a whole enables connectivity between the connected UEs 1412, 1414 and the host computer 1416. The connectivity may be described as an OTT connection 1424. The host computer 1416 and the connected UEs 1412, 1414 are configured to communicate data and/or signaling via the OTT connection 1424, using the access network 1402, the core network 1404, any intermediate network 1422, and possible further infrastructure (not shown) as intermediaries. The OTT connection 1424 may be transparent in the sense that the participating communication devices through which the OTT connection 1424 passes are unaware of routing of uplink and downlink communications. For example, the base station 1406 may not or need not be informed about the past routing of an incoming downlink communication with data originating from the host computer 1416 to be forwarded (e.g., handed over) to a connected UE 1412. Similarly, the base station 1406 need not be aware of the future routing of an outgoing uplink communication originating from the UE 1412 towards the host computer 1416.

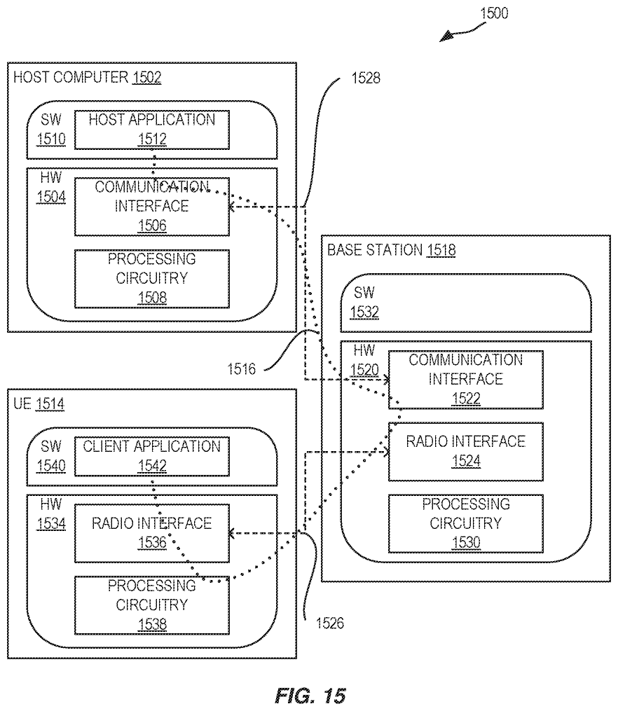

FIG. 15 is a generalized block diagram of a host computer communicating via a base station with a UE over a partially wireless connection in accordance with some embodiments of the present disclosure. Example implementations, in accordance with an embodiment, of the UE, base station, and host computer discussed in the preceding paragraphs will now be described with reference to FIG. 15. In a communication system 1500, a host computer 1502 comprises hardware 1504 including a communication interface 1506 configured to set up and maintain a wired or wireless connection with an interface of a different communication device of the communication system 1500. The host computer 1502 further comprises processing circuitry 1508, which may have storage and/or processing capabilities. In particular, the processing circuitry 1508 may comprise one or more programmable processors, ASICs, FPGAs, or combinations of these (not shown) adapted to execute instructions. The host computer 1502 further comprises software 1510, which is stored in or accessible by the host computer 1502 and executable by the processing circuitry 1508. The software 1510 includes a host application 1512. The host application 1512 may be operable to provide a service to a remote user, such as a UE 1514 connecting via an OTT connection 1516 terminating at the UE 1514 and the host computer 1502. In providing the service to the remote user, the host application 1512 may provide user data which is transmitted using the OTT connection 1516.

The communication system 1500 further includes a base station 1518 provided in a telecommunication system and comprising hardware 1520 enabling it to communicate with the host computer 1502 and with the UE 1514. The hardware 1520 may include a communication interface 1522 for setting up and maintaining a wired or wireless connection with an interface of a different communication device of the communication system 1500, as well as a radio interface 1524 for setting up and maintaining at least a wireless connection 1526 with the UE 1514 located in a coverage area (not shown in FIG. 15) served by the base station 1518. The communication interface 1522 may be configured to facilitate a connection 1528 to the host computer 1502. The connection 1528 may be direct or it may pass through a core network (not shown in FIG. 15) of the telecommunication system and/or through one or more intermediate networks outside the telecommunication system. In the embodiment shown, the hardware 1520 of the base station 1518 further includes processing circuitry 1530, which may comprise one or more programmable processors, ASICs, FPGAs, or combinations of these (not shown) adapted to execute instructions. The base station 1518 further has software 1532 stored internally or accessible via an external connection.

The communication system 1500 further includes the UE 1514 already referred to. The UE's 1514 hardware 1534 may include a radio interface 1536 configured to set up and maintain a wireless connection 1526 with a base station serving a coverage area in which the UE 1514 is currently located. The hardware 1534 of the UE 1514 further includes processing circuitry 1538, which may comprise one or more programmable processors, ASICs, FPGAs, or combinations of these (not shown) adapted to execute instructions. The UE 1514 further comprises software 1540, which is stored in or accessible by the UE 1514 and executable by the processing circuitry 1538. The software 1540 includes a client application 1542. The client application 1542 may be operable to provide a service to a human or non-human user via the UE 1514, with the support of the host computer 1502. In the host computer 1502, the executing host application 1512 may communicate with the executing client application 1542 via the OTT connection 1516 terminating at the UE 1514 and the host computer 1502. In providing the service to the user, the client application 1542 may receive request data from the host application 1512 and provide user data in response to the request data. The OTT connection 1516 may transfer both the request data and the user data. The client application 1542 may interact with the user to generate the user data that it provides.

It is noted that the host computer 1502, the base station 1518, and the UE 1514 illustrated in FIG. 15 may be similar or identical to the host computer 1416, one of the base stations 1406A, 1406B, 14060, and one of the UEs 1412, 1414 of FIG. 14, respectively. This is to say, the inner workings of these entities may be as shown in FIG. 15 and independently, the surrounding network topology may be that of FIG. 14.

In FIG. 15, the OTT connection 1516 has been drawn abstractly to illustrate the communication between the host computer 1502 and the UE 1514 via the base station 1518 without explicit reference to any intermediary devices and the precise routing of messages via these devices. The network infrastructure may determine the routing, which may be configured to hide from the UE 1514 or from the service provider operating the host computer 1502, or both. While the OTT connection 1516 is active, the network infrastructure may further take decisions by which it dynamically changes the routing (e.g., on the basis of load balancing consideration or reconfiguration of the network).

The wireless connection 1526 between the UE 1514 and the base station 1518 is in accordance with the teachings of the embodiments described throughout this disclosure. One or more of the various embodiments improve the performance of OTT services provided to the UE 1514 using the OTT connection 1516, in which the wireless connection 1526 forms the last segment. More precisely, the teachings of these embodiments allow online services applications and AFs to request handover and thereby provide benefits such as improved control over the UE's mobility trajectory and the ability to select RATs, PLMNs, and cells based on non-standard criteria that may result in a better end user experience.

A measurement procedure may be provided for the purpose of monitoring data rate, latency, and other factors on which the one or more embodiments improve. There may further be an optional network functionality for reconfiguring the OTT connection 1516 between the host computer 1502 and the UE 1514, in response to variations in the measurement results. The measurement procedure and/or the network functionality for reconfiguring the OTT connection 1516 may be implemented in the software 1510 and the hardware 1504 of the host computer 1502 or in the software 1540 and the hardware 1534 of the UE 1514, or both. In some embodiments, sensors (not shown) may be deployed in or in association with communication devices through which the OTT connection 1516 passes; the sensors may participate in the measurement procedure by supplying values of the monitored quantities exemplified above, or supplying values of other physical quantities from which the software 1510, 1540 may compute or estimate the monitored quantities. The reconfiguring of the OTT connection 1516 may include message format, retransmission settings, preferred routing, etc.; the reconfiguring need not affect the base station 1518, and it may be unknown or imperceptible to the base station 1518. Such procedures and functionalities may be known and practiced in the art. In certain embodiments, measurements may involve proprietary UE signaling facilitating the host computer's 1502 measurements of throughput, propagation times, latency, and the like. The measurements may be implemented in that the software 1510 and 1540 causes messages to be transmitted, in particular empty or ‘dummy’ messages, using the OTT connection 1516 while it monitors propagation times, errors, etc.

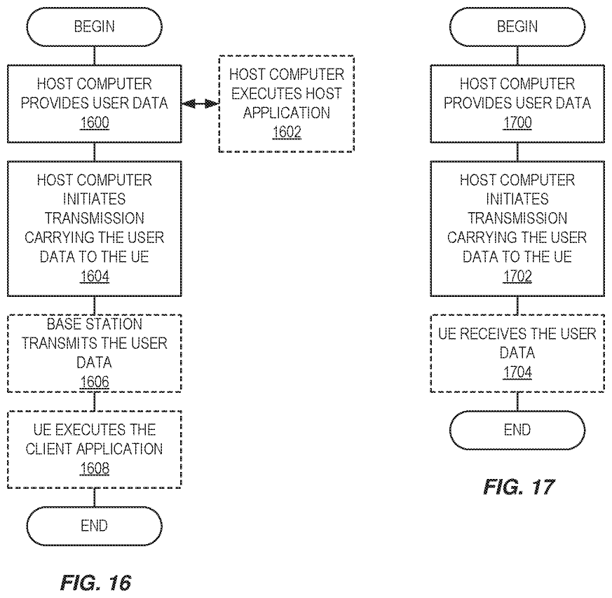

FIG. 16 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 16 will be included in this section. In step 1600, the host computer provides user data. In sub-step 1602 (which may be optional) of step 1600, the host computer provides the user data by executing a host application. In step 1604, the host computer initiates a transmission carrying the user data to the UE. In step 1606 (which may be optional), the base station transmits to the UE the user data which was carried in the transmission that the host computer initiated, in accordance with the teachings of the embodiments described throughout this disclosure. In step 1608 (which may also be optional), the UE executes a client application associated with the host application executed by the host computer.

FIG. 17 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 17 will be included in this section. In step 1700 of the method, the host computer provides user data. In an optional sub-step (not shown) the host computer provides the user data by executing a host application. In step 1702, the host computer initiates a transmission carrying the user data to the UE. The transmission may pass via the base station, in accordance with the teachings of the embodiments described throughout this disclosure. In step 1704 (which may be optional), the UE receives the user data carried in the transmission.

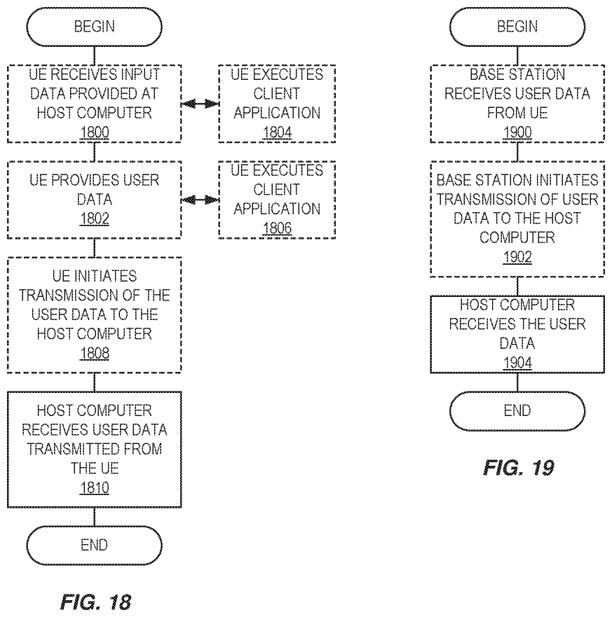

FIG. 18 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 18 will be included in this section. In step 1800 (which may be optional), the UE receives input data provided by the host computer. Additionally or alternatively, in step 1802, the UE provides user data. In sub-step 1804 (which may be optional) of step 1800, the UE provides the user data by executing a client application. In sub-step 1806 (which may be optional) of step 1802, the UE executes a client application which provides the user data in reaction to the received input data provided by the host computer. In providing the user data, the executed client application may further consider user input received from the user. Regardless of the specific manner in which the user data was provided, the UE initiates, in sub-step 1808 (which may be optional), transmission of the user data to the host computer. In step 1810 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 19 will be included in this section. In step 1900 (which may be optional), in accordance with the teachings of the embodiments described throughout this disclosure, the base station receives user data from the UE. In step 1902 (which may be optional), the base station initiates transmission of the received user data to the host computer. In step 1904, the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

The advantages provided by the present disclosure include, but are not limited to, empowering Online Services Application Functions such as Facebook, Google and Amazon to request Hand Overs, and giving the Mobile Network Operators an alternative to monetize their network capabilities from OTT flow of money via charging for the use of this new API.

At least some of the following abbreviations may be used in this disclosure. If there is an inconsistency between abbreviations, preference should be given to how it is used above. If listed multiple times below, the first listing should be preferred over any subsequent listing(s).
2G Second Generation
3G Third Generation
3GPP Third Generation Partnership Project
5G Fifth Generation
5GC Fifth Generation Core Network
AF Application Function
AMF Core Access and Mobility Management Function
AN Access Node
AP Access Point
API Application Programming Interface
ASIC Application Specific Integrated Circuit
AUSF Authentication Server Function
BBU Baseband Unit
CM-IDLE Connection Management Idle state
CN Core Network
CPE Customer Premise Equipment
CPU Central Processing Unit
DN Data Network
DSP Digital Signal Processor
eNB Enhanced or Evolved Node B
FPGA Field Programmable Gate Array
GHz Gigahertz
gNB New Radio Base Station
GUTI Globally Unique Temporary Identity
HSS Home Subscriber Service
ID Identifier f Identity
IP Internet Protocol
LBO Local Breakout
LoRa Long Range (wireless data communication)
LTE Long Term Evolution
MME Mobility Management Entity
MNO Mobile Network Operator
MTC Machine Type Communication
NB Node B
NEF Network Exposure Function
NF Network Function
NG-RAN Next Generation Radio Access Network
NR New Radio
NRF Network Repository Function
NSSF Network Slice Selection Function
NWDAF Network Data Analytics Function
OTT Over-the-Top
PCF Policy Control Function
PDU Protocol Data Unit
P-GW Packet Data Network Gateway
PLMN Public Land Mobile Network
QoE Quality of Experience
QoS Quality of Service
RAM Random Access Memory
RAN Radio Access Network
RAT Radio Access Technology
REST Representational State Transfer protocol
ROM Read Only Memory
RRC Radio Resource Control
RRH Remote Radio Head
RRU Remote Radio Unit
RTT Round Trip Time
S-AMF Source Core Access and Mobility Management Function
S-RAN Source Radio Access Network
SCEF Service Capability Exposure Function
SMF Session Management Function
T-AMF Target Core Access and Mobility Management Function
T-RAN Target Radio Access Network
TS Technical Specification
UAV Unmanned Aerial Vehicle
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method for applications within or attached to a client device to request handover, the method comprising:
at the client device:
receiving, at an Application Programming Interface, API, layer within the client device, a first request to trigger a handover required message;
sending, by the API layer to a modem within the client device, the first request;
preparing, by the modem, a handover required message; and
sending, by the modem, the handover required message to a Radio Access Node, RAN, serving the client device.

2. The method of claim 1 further comprising upon receiving the first request, determining whether the first request is allowed and sending the first request to the modem only when the first request is allowed.

3. The method of claim 1 wherein receiving the first request comprises receiving the first request from a native application within the client device.

4. The method of claim 3 wherein the native application comprises a browser or a social media application.

5. The method of claim 1 wherein receiving the first request comprises receiving the first request from an external application attached to the client device.

6. The method of claim 5 wherein receiving the request from the external application comprises receiving the request via an external interface of the client device.

7. The method of claim 6 wherein the external interface of the client device comprises a wired or wireless interface.

8. The method of claim 1 wherein sending the handover required message to the RAN comprises sending the handover required message as an N1 interface signaling message to the RAN.

9. The method of claim 1 further comprising, prior to receiving the first request to trigger a handover required message:
sending, by a requesting application to an Application Function, AF, a request to certify the requesting application; and
receiving, from the AF, a response to the request to certify the requesting application.

10. The method of claim 9 wherein the received response indicates that the requesting application is certified.

11. The method of claim 10 wherein the response comprises a certificate for use by the requesting application.

12. The method of claim 11 further comprising:
sending, by the requesting application to the API layer, a request to validate the received certificate;
sending, by the API layer to a Network Exposure Function, NEF, the request to validate the certificate;
receiving, by the API layer from the NEF, a notification that the certificate is valid or invalid; and
forwarding, by the API layer to the requesting application, the received notification that the certificate is valid or invalid.

13. A client device for operating in a telecommunications network and that allows applications within or attached to the client device to request handover, the client device being adapted to:
receive, at an Application Programming Interface, API, layer, a first request to trigger a handover required message;
send, by the API layer to a modem within the client device, the first request;
prepare, by the modem, a handover required message; and
send, by the modem, the handover required message to a Radio Access Node, RAN, serving the client device.

14-24. (canceled)

25. A method for an Application Function, AF, operating in a telecommunications network to request handover, the method comprising:
at the AF:
detecting a handover required condition; and
notifying, directly or via a Network Exposure Function, NEF, a Core Access and Mobility Management Function, AMF, that a handover is required.

26. An Application Function, AF, for operating in a telecommunications network, the AF being adapted to:
detect a handover required condition; and
notify, directly or via a Network Exposure Function, NEF, a Core Access and Mobility Management Function, AMF, that a handover is required.

27-49. (canceled)

50. A method in a telecommunications network to request handover, the method comprising:
at a Network Exposure Function, NEF:
receiving a handover required request from an Application Function, AF;
querying a Unified Data Management, UDM, node, for an identity of a Serving Core Access and Mobility Management Function, S-AMF;
receiving, from the UDM node, the identity of the S-AMF; and
sending, to the identified S-AMF, the handover required request; and
at the S-AMF:
receiving, from the AF, the handover required request; and
processing the received handover required request.

51. The method of claim 50, further comprising at the NEF:
prior to querying the UDM node, validating the handover required request received from the AF.

52. The method of claim 51 wherein validating the handover required request received from the AF comprises using a User Equipment, UE, reachability procedure to validate rights of the AF.
